(19) United States
(12) Patent Application Publication
(10) Pub. No.: US 2003/0197514 A1
(43) Pub. Date: Oct. 23, 2003

(54) System and method for testing a printed circuit board by employing a ceramic substrate with micro-probes formed on the ceramic substrate

(76) Inventor: Howard Hsu, Chungho City (TW)

Correspondence Address: Jones, Tullar & Cooper, P.C., Suite 1002, 2001 Jefferson Davis Highway, Arlington, VA, 22202, US

(21) Appl. No.: 10/126,628

(22) Filed: Apr. 22, 2002

(51) Int. Cl. H01H 31/02

(52) U.S. Cl. 324/537

(57) ABSTRACT

A method for testing a printed circuit board (PCB), such as the FCP or CSP substrate, employs a ceramic substrate with multiple micro-probes formed on the ceramic substrate. The micro-probes are formed in a high density arrangement to electrically contact conductive vias defined on the PCB. The ceramic substrate further connects to a test apparatus. The test apparatus can output test signals through the micro-probes to the conductive vias on the PCB. Thereafter, the test apparatus can check and determine whether the PCB is normal or not. When applying the method to test PCBs, the required testing time can be greatly reduced, even when employing the testing method on a PCB with high-density conductive vias.

### BACKGROUND OF THE INVENTION

1. Field of Invention

The present invention relates to a system and method for testing a printed circuit board (PCB), such as a substrate with high density pins for the flip chip packaging (FCP) or the chip scale packaging (CSP), and more particularly to a system employing a ceramic substrate with multiple testing micro-probes formed on the ceramic substrate to check whether the PCB is faulty or not.

2. Related Art

In the integrated circuit (IC) fabrication process, the product quality is always the chief consideration. IC quality is primarily determined by two factors, the integrated chip and the printed circuit board (PCB). Therefore, the quality of the PCB needs to be controlled as strictly as the quality of the integrated chip.

Basically, the PCB is designed with chip mounting areas for electrically connect with the chips. For example, the mounting area of a ball grid array (BGA) circuit board is formed with multiple conductive vias to contact the conductive balls on the bottom surface of a BGA chip. The conventional testing method to check whether the BGA circuit board is faulty or not generally employs a pair of probes or multiple probes.

When using a pair of probes to check the BGA circuit board, one of the paired probes contacts a conductive via on the top surface of BGA circuit board, and the other one is provided to contact a corresponding conductive pad formed on the bottom surface of the BGA circuit board. However, the pair of probes need to sequentially contact every conductive via and every corresponding conductive pad to completely test the circuit board. Such a testing process requires an excessive amount of time.

On the other hand, multiple probes may not be able to be used to test the high-density conductive vias on the circuit board because the diameter (more than 350 μm) of each probe is too thick.

To overcome the shortcomings, the present invention provides a system and method for testing a PCB by a ceramic substrate that has multiple micro-probes to mitigate and obviate the aforementioned problems.

### SUMMARY OF THE INVENTION

An objective of the PCB testing method in accordance with the present invention is to shorten the time spent performing quality checks on PCBs and to provide a testing method that is suitable for application with the high density conductive vias on a PCB.

Other objectives, advantages and novel features of the invention will become more apparent from the following detailed description when taken in conjunction with the accompanying drawings.

### BRIEF DESCRIPTION OF THE DRAWINGS

FIG. 1 is a top plan view of a ball grid array (BGA) printed circuit board that is used as a testing sample;

FIG. 2 is a enlarged cross-section view in partial section of the BGA printed circuit board taken from a line 2-2 shown in FIG. 1 showing a single chip mounting unit;

FIG. 3 is a side plan view of a ceramic substrate with micro-probes;

FIG. 4 is a perspective view of the bottom of the ceramic substrate in FIG. 3;

FIG. 5 is a perspective view of the top of the ceramic substrate in FIG. 3; and

FIG. 6 is an operational side plan view showing the ceramic substrate used to check a printed circuit board in accordance with the present invention.

### DETAILED DESCRIPTION OF THE INVENTION

With reference to FIG. 1, a ball grid array (BGA) substrate (10) is used for illustrative purposes only as the printed circuit board (PCB) in the description of testing method in accordance with the present invention. Also, the present invention can apply to test a chip scale packaging (CSP) substrate. The BGA substrate (10) has a top and bottom surface and is designed with nine mounting units (11) on the top surface. It is needed to note that the quantity of the mounting units (11) are depended on an application circuit design, and the micro-probe that will be introduced in the following description is modified based on the design of the BGA substrate (10).

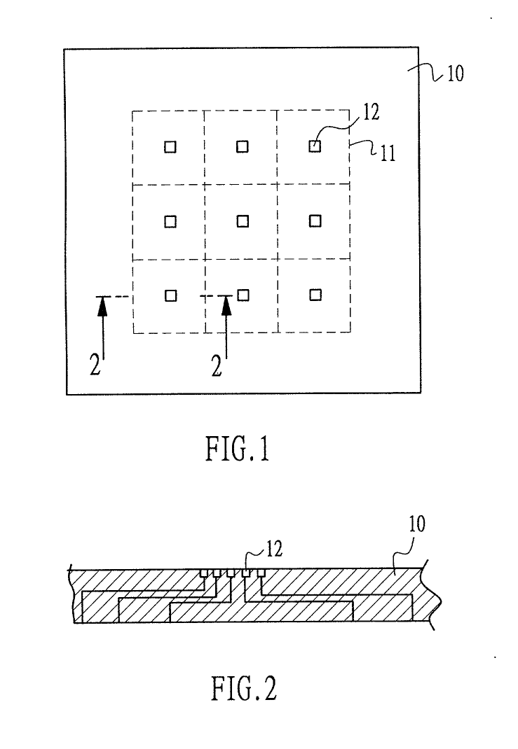

With reference to FIG. 2, each mounting unit (11) is formed with multiple conductive vias (12) on the top surface of the substrate (10) to connect to a chip (not shown). The conductive vias (12) are electrically connected to corresponding conductive points (not shown), such as solder balls, arranged on a bottom surface of the substrate (10) through the circuit layout inside the substrate (10).

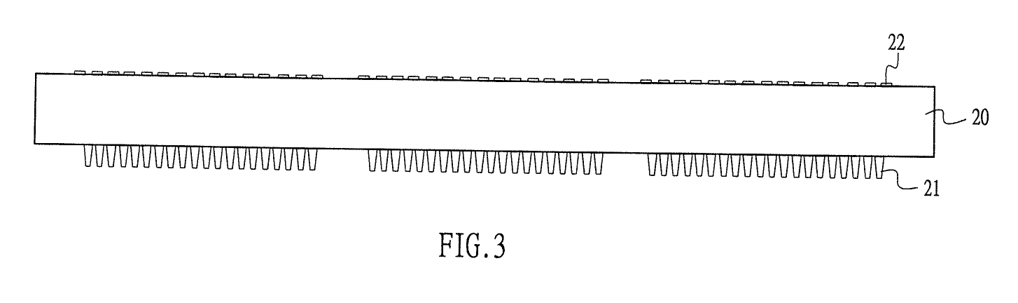

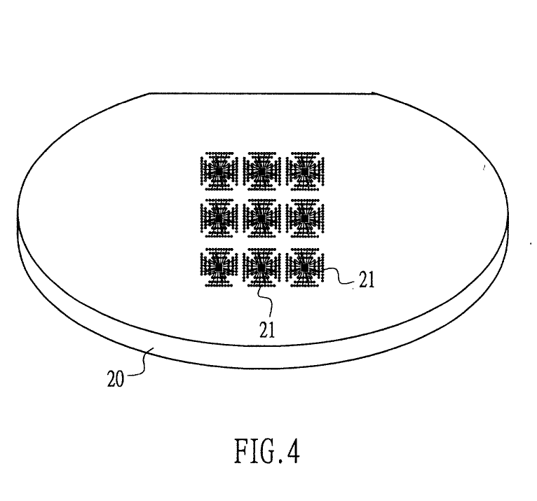

With reference to FIGS. 3 and 4, a ceramic substrate (20) has a top and bottom surface, and multiple conductive micro-probes (21) are formed on the bottom surface. The micro-probes (21) can be fabricated by MEMS (Micro-Electrical Machinery System). The micro-probes (21) can be divided into nine units to respectively correspond to the mounting units (11) on the BGA substrate (10). By employing the MEMS technique, the pitch between adjacent micro-probes (21) can be fabricated to be less than 150 μm, the length of each micro-probe (21) can be longer than 40 μm, and the diameter of each micro-probe (21) is less than 20 μm.

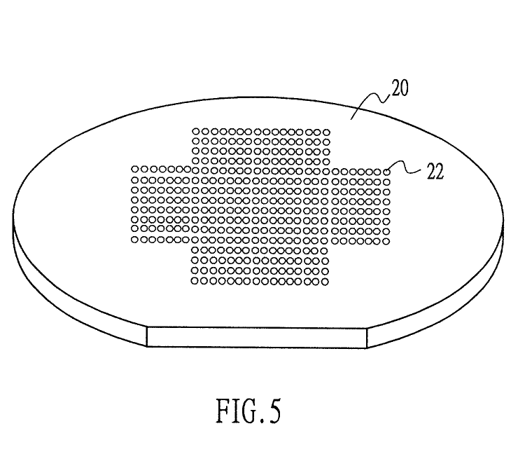

With reference to FIGS. 3, 5 and 6, conducting pads (22) are formed on the top surface of the ceramic substrate (20). Each conducting pad (22) is electrically connected to a corresponding micro-probe (21) on the bottom surface of the ceramic substrate (20) though an internal circuit in the ceramic substrate (20). The conducting pads (22) further contact with an elastic conductive pin array (220). The conductive pin array (220) is further link to a test apparatus (100) via a signal bus (23).

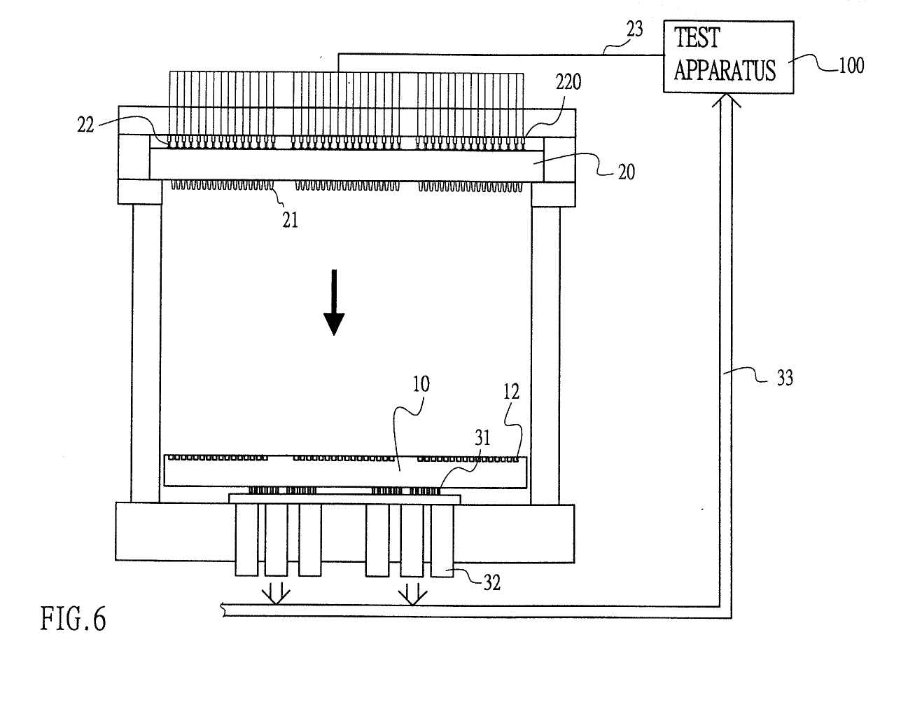

With reference to FIG. 6, when the BGA substrate (10) and the ceramic substrate (20) are prepared, the BGA substrate (10) is mounted on a fixture device (30). When the BGA substrate (10) is guided to the correct position by some conventional means, such as the use of charge-coupled device (CCD) camera alignment means and a X-Y-θ table, the bottom surface of the BGA substrate (10) contacts multiple testing pin arrays (31). The testing pin arrays (31) are electrically connected to the testing apparatus (100) through testing pin array cylinders (32) and signal bus (33).

When the BGA substrate (10) is guided into position, the ceramic substrate (20) is moved downward, so that the micro-probes (21) formed on the bottom surface electrically contact the corresponding conductive vias (12) on the top surface of the BGA substrate (10). Since the micro-probes (21) are electrically connected to the signal bus (23) through the conducting pads (22) and the signal bus (23) are linked to the testing apparatus (100), the testing apparatus (100) can output current controlled by computer programs to the BGA substrate (10) to examine whether the substrate (10) has any faults (i.e. short circuit or open circuit) or not.

For example, when the testing apparatus (100) outputs open/short testing signals (such as high/low voltage signals) through the ceramic substrate (20) into the BGA substrate (10), the testing apparatus (100) can check the BGA substrate (10) based on the returned signals from the testing pin arrays (31). If each conductive via (12) is correctly connected to the corresponding conductive point, the returned signals exactly represent the input high or low voltage level. Thus, the BGA substrate (10) can be affirmed as a normal substrate.

From the foregoing description, the PCB testing method in accordance with the present invention can be concluded to as comprises the following steps.

1. Preparing a printed circuit board (PCB) with a top and bottom surface, wherein conductive vias are formed on the top surface of the PCB, contact points are formed on the bottom surface of the PCB, and the vias and contact points are connected by internal circuitry in the PCB. The contact points on the bottom of the PCB can be conductive balls, solder pads, etc.

2. Preparing a ceramic substrate with a top and bottom surface with multiple micro-probes formed on the bottom surface of the ceramic substrate, wherein the micro-probes are arranged to correspond to the conductive vias on the PCB, and conducting pads are formed on the top surface of the ceramic substrate to link to a test apparatus through an elastic conductive pin array that can be connected with the conducting pads and a signal bus.

3. Electrically connecting the signal bus on the ceramic substrate to a test apparatus.

4. Mounting the PCB on a fixture device, wherein the PCB electrically contacts the fixture device, and the fixture device is further linked to the test apparatus.

5. Contacting the micro-probes on the ceramic substrate to the conductive vias on the PCB when the ceramic substrate is load down.

6. Outputting test signals from the test apparatus through the ceramic substrate to the PCB.

7. Checking whether the PCB has any faults based on returned signals from the PCB and the ceramic substrate by the testing apparatus.

From the foregoing description of the embodiment, the system and method in accordance with the present invention has advantages over the prior art that include the following

1. The testing system utilizes MEMS (Micro0Electrical Machinery System) technique to form the micro-probes, whereby the low arrangement density and the thick diameter of the conventional testing probes can be overcome. Specially, the testing method is convenience for testing the substrate with high density pins.

2. Since the micro-probes in accordance with the present invention are fabricated on the ceramic substrate as a high density arrangement, all the testing points on the PCB can simultaneously be tested, thus the testing time can be greatly reduced.

3. Module design: To test the different kinds of the PCBs or substrates, the testing system just needs to change the corresponding ceramic substrate.

4. When the micro-probes are abrasive, the micro-probes can be easily reconstructed by MEMS.

5. Since each micro-probe only contacts each conductive via of the substrate with a tiny area, the damaged to the substrate is controlled to be the minimum.

The invention may be varied in many ways by a skilled person in the art. Such variations are not to be regarded as a departure from the spirit and scope of the invention, and all such modifications are intended to be included within the scope of the following claims.

What is claimed is:

1. A method for testing a print circuit board, the method comprising the steps of:
preparing a printed circuit board (PCB) with a top and bottom surface, wherein conductive vias are formed on the top surface of the PCB, contact points are formed on the bottom surface of the PCB and the vias and contact points are connected by internal circuitry in the PCB;
preparing a ceramic substrate with a top and bottom surface with multiple micro-probes formed on the bottom surface of the ceramic substrate, wherein the micro-probes are arranged to correspond to the conductive vias on the PCB and conducting pads are formed on the top surface of the ceramic substrate, thereafter the conducting pads electrically contact an elastic pin array that is further linked to a test apparatus through a signal bus;
mounting the PCB on a fixture device, wherein the PCB electrically contacts the fixture device, and the fixture device is further linked to the testing apparatus;
contacting the micro-probes on the ceramic substrate to the conductive vias on the PCB when the ceramic substrate is load down;
outputting test signals from the test apparatus through the ceramic substrate to the PCB;
checking whether the PCB has any faults by the test apparatus based on returned signals from the PCB through the ceramic substrate.

2. The method as claimed in claim 1, wherein the multiple micro-probes are fabricated by micro-electrical machinery system (MEMS).

3. The method as claimed in claim 1, wherein after PCB mounting step, the PCB is guided to a correct position by a charge-coupled device (CCD) camera and a X-Y-θ table alignment means.

4. The method as claimed in claim 1, wherein the PCB is a ball grid array (BGA) substrate with a top and bottom surface that has with conductive points mounted the bottom surface to electrically contact the fixture device.

5. The method as claimed in claim 1, wherein a pitch between the two adjacent micro-probes is less than 150 μm.

6. The method as claimed in claim 1, wherein a length of the micro-probe is longer than 40 μm.

7. The method as claimed in claim 1, wherein a diameter of the micro-probe is less than 20 μm.

8. A system for testing a print circuit board, the system comprising:
a printed circuit board (PCB) with a top and bottom surface, wherein conductive vias are formed on the top surface of the PCB, contact points are formed on the bottom surface of the PCB and the vias and contact points are connected by internal circuitry in the PCB;
a ceramic substrate with a top and bottom surface with multiple micro-probes formed on the bottom surface of the ceramic substrate, wherein the micro-probes are arranged to correspond to the conductive vias on the PCB and conducting pads are formed on the top surface of the ceramic substrate, thereafter the conducting pads electrically contact an elastic pin array that is further linked to a test apparatus through a signal bus;
a fixture device, wherein the PCB is mounted on the fixture dive and electrically contacts the fixture device, and the ceramic substrate is moveablely mounted on the fixture device and positioned above the PCB, further the fixture device is linked to the testing apparatus;
thereafter the micro-probes on the ceramic substrate is controlled to contact to the conductive vias on the PCB, and the test apparatus outputs test signals through the ceramic substrate to the PCB, whereby the test apparatus checks whether the PCB has any faults based on returned signals from the PCB through the ceramic substrate.

9. The system as claimed in claim 8, wherein the multiple micro-probes are fabricated by micro-electrical machinery system (MEMS).

10. The system as claimed in claim 8, the PCB is guided to a correct position by a charge-coupled device (CCD) camera and a X-Y-θ table alignment means.

11. The system as claimed in claim 8, wherein the PCB is a ball grid array (BGA) substrate with a top and bottom surface that has conductive points mounted the bottom surface to electrically contact the fixture device.

12. The system as claimed in claim 8, wherein a pitch between the two adjacent micro-probes is less than 150 μm.

13. The system as claimed in claim 8, wherein a length of the micro-probe is longer than 40 μm.

14. The system as claimed in claim 8, wherein a diameter of the micro-probe is less than 20 μm.

15. The system as claimed in claim 8, wherein the PCB is a flip chip packaging (FCP) substrate.

16. The system as claimed in claim 8, wherein the PCB is a chip scale packaging (CSP) substrate.
